(19) United States
(12) Patent Application Publication
(10) Pub. No.: US 2026/0072427 A1
(43) Pub. Date: Mar. 12, 2026

(54) SYSTEM AND METHOD FOR IDENTIFYING POTENTIAL PROCESS VARIABLES CAUSING KPI DEVIATION

(71) Applicant: Honeywell International Inc., Charlotte, NC (US)

(72) Inventors: Praveen Tayal, Hyderabad (IN); Amit Pandey, Hyderabad (IN); Sharan Nagarajan, Bangalore (IN); Satrujeet Dey, Bangalore (IN); Zameer Patel, Calgary (CA)

(21) Appl. No.: 18/827,897

(22) Filed: Sep. 9, 2024

(51) Int. Cl. G05B 23/02

(52) U.S. Cl. CPC G05B 23/0275; G05B 23/024

(57) ABSTRACT

The present disclosure discloses a system and a method for identifying root-cause in potential process variables causing KPI deviation in the industrial process. The system identifies the root-cause in the process variables causing the KPI deviation based on a knowledge graph, a causal effect, and a relation between the process variables. The disclosed system and method improve the overall performance of the industrial process and prevent future KPI deviations in the industrial process.

### FIELD OF INVENTION

The present disclosure generally relates to a performance management of process variables in an industrial process. More specifically, the present disclosure provides a system and a method for identifying root-cause in potential process variables causing KPI deviation in the industrial process.

### BACKGROUND

The subject matter discussed in the background section should not be assumed to be prior art merely as a result of its mention in the background section. Similarly, a problem mentioned in the background section or associated with the subject matter of the background section should not be assumed to have been previously recognized in the prior art. The subject matter in the background section merely represents different approaches, which in and of themselves may also correspond to implementations of the claimed technology.

Industrial processes are equipped with many assets that are associated with hundreds or even thousands of process variables. Key Performance Indicators (KPIs) are key parameters to manage the operational performance of the process variables. The KPIs indicate process throughput, conversion efficiency, energy consumption, production rates, product quality, product properties, and the like.

The KPIs are dependent on the performance of the process variables. The process variables are generally connected in a complex network. Further, the process variables generate a large volume of operational data making it difficult to understand their dependencies and their impact on the overall performance of the industrial plant process. When deviations in KPIs occur, it becomes crucial to identify the potential process variables for taking corrective actions. However, due to the large number of process variables and their intricate dependencies, this task becomes time-consuming and challenging.

Further, industrial processes are dynamic with time dependency and feedback loops. Specifically, an industrial process normally involves subunits that interact with each other, e.g., assets, and process variables interact with each other. The propagation speed of signal or information between the subunits becomes relevant for the overall dynamics of the industrial process. However, these subunits exhibit time delay in the propagation of the signal. This results in non-linear characteristics, causing complex dynamical behavior. For instance, in the industrial process, maintaining the reactor temperature (process variable) helps in production yield (target KPI). In general, a domain expertise performs the supervision to observe and maintain the KPIs in the industrial process. Further, the domain expert also observes the root-cause for KPI deviation.

However, in certain scenarios, for example, the reactor temperature and the production yield have a direct association with each other, and therefore, the domain expert might not consider other factors for a change in production yield. Thus, it is difficult to know the causal effect even with the aid of highly trustworthy domain expertise. Thus, it is difficult to identify the potential process variables causing KPI deviation and to take timely action to rectify the root-cause of the KPI deviation.

Traditional methods are limited to detect-and-diagnose methods. For instance, the subject matter experts handpick process variables in the industrial process and those process variables are used by the experts to first detect the fault, like an anomaly detection. After the detection of the fault, the potential process variables causing KPI deviation are identified from those handpicked process variables. These detect-and-diagnose methods rely heavily on the knowledge of the subject matter experts and many times the subject matter experts are not aware of the blind spots and a causal effect in these complex and dynamic industrial processes. Therefore, these traditional methods may work sometimes but it is difficult to scale the solution on process data generated in an industrial process.

Thus, a deep analysis of the cause-and-effect relationships between the process variables and the KPIs becomes a relevant issue for developing actions to improve performance and prevent future KPI deviations in an industrial process. Thus, there is a need to provide a system and a method to mitigate the above-mentioned issues related identification of process variables causing KPI deviation in an industrial process.

Through applied effort, ingenuity, and innovation, the inventors have solved and proposed the above problem(s) by developing the solutions embodied in the present disclosure, the details of which are described further herein.

### SUMMARY OF THE INVENTION

In general, embodiments of the present disclosure herein provide a solution for identifying root-cause in process variables causing Key Performance Indicator (KPI) deviation in an industrial process. Other implementations will be or will become, apparent to one with skill in the art upon examination of the following figures and detailed description. It is intended that all such additional implementations be included within this description within the scope of the disclosure.

In one embodiment, the present disclosure discloses a method for identifying root-cause in process variables causing Key Performance Indicator (KPI) deviation in an industrial process. The method includes determining, using ML models, a changed performance characteristics in each asset among a plurality of assets based on a comparison of an expected performance characteristics with respect to a real-time (RT) performance characteristics of each asset. The method further includes identifying, based on a result of the determination, a set of key process variables, from a plurality of process variables associated with each asset, wherein the set of key process variables includes one or more key process variables that exhibit the changed performance characteristics. Further, the method includes clustering the one or more key process variables exhibiting a similar pattern of the changed performance characteristics to form one or more groups. Further, the method includes selecting, from each one or more groups, a set of substantial process variables exhibiting deviated KPI performance with respect to a target KPI performance based on a distance-based co-relation analysis on the RT performance characteristics of each one or more key process variables with respect to the target KPI performance, wherein the set of substantial process variables includes at least one process variable. Further, the method includes determining a causal effect and causal relation between each substantial process variable in the set of substantial process variables based on a causal analysis on the set of substantial process variables. Further, the method includes determining an order of each substantial process variable causing the KPI deviation based on a knowledge graph. Furthermore, the method includes identifying the root-cause in the process variables causing the KPI deviation based on an impact of the determined order of each substantial process variable, the causal effect, and the causal relation on the plurality of process variables.

According to some embodiment, the present disclosure discloses a system for identifying root-cause process variables causing Key Performance Indicator (KPI) deviation in an industrial process. The system includes one or more processors, the memory, and one or more programs stored in the memory. In an embodiment, the one or more programs when executed by the one or more processors, cause the one or more processors to determine, using ML models, a changed performance characteristics in each asset among a plurality of assets based on a comparison of an expected performance characteristics with respect to a real-time (RT) performance characteristics of each asset. Further, the one or more processors are configured to identify, based on a result of the determination, a set of key process variables, from a plurality of process variables associated with each asset, wherein the set of key process variables includes one or more key process variables that exhibit the changed performance characteristics. Further, the one or more processors are configured to cluster the one or more key process variables exhibiting a similar pattern of the changed performance characteristics to form one or more groups. Further, the one or more processors are configured to select, from each one or more groups, a set of substantial process variables exhibiting deviated KPI performance with respect to a target KPI performance based on a distance-based co-relation analysis on the RT performance characteristics of each one or more key process variables with respect to the target KPI performance, wherein the set of substantial process variables includes at least one process variable. Further, the one or more processors are configured to determine a causal effect and causal relation between each substantial process variable in the set of substantial process variables based on a causal analysis on the set of substantial process variables. Further, the one or more processors are configured to determine an order of each substantial process variable causing the KPI deviation based on a knowledge graph. Further, the one or more processors are configured to identify the root-cause in the process variables causing the KPI deviation based on an impact of the determined order of each substantial process variable, the causal effect, and the causal relation on the plurality of process variables.

According to some embodiment, the present disclosure discloses a non-transitory computer-readable storage medium storing program instructions for performing a root-cause diagnosis of oscillations in one or more assets in an industrial process. According to an embodiment, the instructions when executed, perform the steps of determining, using ML models, a changed performance characteristics in each asset among a plurality of assets based on a comparison of an expected performance characteristics with respect to a real-time (RT) performance characteristics of each asset. The non-transitory computer-readable storage medium further performs: identifying, based on a result of the determination, a set of key process variables, from a plurality of process variables associated with each asset, wherein the set of key process variables includes one or more key process variables that exhibit the changed performance characteristics. The non-transitory computer-readable storage medium further performs: clustering the one or more key process variables exhibiting a similar pattern of the changed performance characteristics to form one or more groups. The non-transitory computer-readable storage medium further performs: selecting, from each one or more groups, a set of substantial process variables exhibiting deviated KPI performance with respect to a target KPI performance based on a distance-based co-relation analysis on the RT performance characteristics of each one or more key process variables with respect to the target KPI performance, wherein the set of substantial process variables includes at least one process variable. The non-transitory computer-readable storage medium further performs: determining a causal effect and causal relation between each substantial process variable in the set of substantial process variables based on a causal analysis on the set of substantial process variables. The non-transitory computer-readable storage medium further performs: determining an order of each substantial process variable causing the KPI deviation based on a knowledge graph. The non-transitory computer-readable storage medium further performs: identifying the root-cause in the process variables causing the KPI deviation based on an impact of the determined order of each substantial process variable, the causal effect, and the causal relation on the plurality of process variables.

The above summary is provided merely for the purpose of summarizing some exemplary embodiments to provide a basic understanding of some aspects of the present disclosure. Accordingly, it will be appreciated that the above-described embodiments are merely examples and should not be construed to narrow the scope or spirit of the present disclosure in any way. It will be appreciated that the scope of the present disclosure encompasses many potential embodiments in addition to those here summarized, some of which will be further described below. Other features, aspects, and advantages of the subject will become apparent from the description, the drawings, and the claims.

### DESCRIPTION OF THE DRAWINGS

Having thus described the embodiments of the disclosure in general terms, reference now will be made to the accompanying drawings, which are not necessarily drawn to scale, and wherein:

FIG. 1 illustrates an example environment of a system for identifying root-cause in process variables causing Key Performance Indicator (KPI) deviation in an industrial process, according to an embodiment of the present disclosure;

FIG. 2 illustrates a general operational flow 200 for identifying root-cause in process variables causing Key Performance Indicator (KPI) deviation in an industrial process, according to an embodiment of the present disclosure;

FIG. 3 illustrates a method flow of processing the process data, according to an embodiment of the present disclosure;

FIG. 4 illustrates a method flow for identifying a set of key process variables that exhibit the changed performance characteristics, according to an embodiment of the present disclosure;

FIG. 5 illustrates an example block diagram of the analysis module depicted in FIG. 1, in accordance with an embodiment of the present disclosure;

FIG. 6 illustrates an example of the forming clusters of a set of key process variables exhibiting changed performance characteristics, according to an embodiment of the present disclosure;

FIG. 7 illustrates an example of co-relation analysis to determine a set of substantial process variables, according to an embodiment of the present disclosure;

FIG. 8 illustrates a method flow of selecting the set of substantial process variables, according to an embodiment of the present disclosure;

FIG. 9 illustrates a method flow for determining the causal effect and causal relation between each substantial process variable, according to an embodiment of the present disclosure;

FIG. 10 illustrates an example of a knowledge graph of an industrial process, according to an embodiment of the present disclosure;

FIG. 11 illustrates a method flow for identifying the root-cause in the process variables causing the KPI deviation using the knowledge graph, according to an embodiment of the present disclosure;

FIG. 12 illustrates a method flow for identifying the root-cause in the process variables causing the KPI deviation based on an impact of the determined order of each substantial process variable, in accordance with an embodiment of the present disclosure; and

FIG. 13 illustrates a general block diagram of the system, according to an embodiment of the present disclosure.

### DESCRIPTION OF THE INVENTION

The detailed description set forth below in connection with the appended drawings is intended as a description of various embodiments of the present invention and is not intended to represent the only embodiments in which the present invention may be practiced. Each embodiment described in this invention is provided merely as an example or illustration of the present invention, and should not necessarily be construed as preferred or advantageous over other embodiments. The detailed description includes specific details for the purpose of providing a thorough understanding of the present invention. However, it will be apparent to those skilled in the art that the present invention may be practiced without these specific details.

Some embodiments of the present disclosure now will be described more fully hereinafter with reference to the accompanying drawings, in which some, but not all, embodiments of the disclosure are shown. Indeed, embodiments of the disclosure may be embodied in many different forms and should not be construed as limited to the embodiments set forth herein, rather, these embodiments are provided so that this disclosure will satisfy applicable legal requirements. Like numbers refer to like elements throughout.

As used herein, the term “comprising” means including but not limited to and should be interpreted in the manner it is typically used in the patent context. Use of broader terms such as comprises, includes, and having should be understood to provide support for narrower terms such as consisting of, consisting essentially of, and comprised substantially of.

The phrases “in one embodiment,” “according to one embodiment,” “in some embodiments,” and the like generally mean that the particular feature, structure, or characteristic following the phrase may be included in at least one embodiment of the present disclosure, and may be included in more than one embodiment of the present disclosure (importantly, such phrases do not necessarily refer to the same embodiment).

The word “example” or “exemplary” is used herein to mean “serving as an example, instance, or illustration.” Any implementation described herein as “exemplary” is not necessarily to be construed as preferred or advantageous over other implementations.

In one embodiment, the present disclosure discloses a system and a method for identifying root-cause in process variables causing Key Performance Indicator (KPI) deviation in an industrial process. In particular, the present disclosure identifies potential process variables and identifies the root-cause in the process variables causing the KPI deviation.

According to an embodiment, for a given N measurements of M process variables of control loops in the process, the identification of the root-cause in process variables causing the KPI deviation method primarily performs the following key operations:
1. Pre-processing the Process Data: This is an automated approach where the process data is pre-processed to remove outliers, imputing missing data, and the like.
2. Determining Changed Performance Characteristics: According to this automated approach, changed performance characteristics in each asset are determined based on a comparison of an expected performance characteristics with respect to a real-time (RT) performance characteristics of each asset.
3. Identification of key process variables: Based on the result of the determination of the changed performance characteristics, a set of key process variables are identified from a plurality of process variables exhibiting the changed performance characteristics associated with each asset.
4. Cluster Key Process Variables: According to this automated approach, key process variables exhibiting a similar pattern of the changed performance characteristics are clustered to form a group of key process variables.
5. Perform Co-relation Analysis: According to this automated approach, a co-relation analysis is performed on each of the groups of key process variables to select a set of substantial process variables, from each group, exhibiting deviated KPI performance with respect to a target KPI performance.
6. Perform Causality Analysis: According to this automated approach, a causality analysis is performed on the substantial process variables to obtain a causal effect and causal relation between each substantial process variable.
7. Determine an Order of Substantial Process Variables: According to this automated approach, an order of each substantial process variable causing the KPI deviation is determined based on a knowledge graph.
8. Identify Root Cause Process Variables Causing KPI Deviation: According to this automated approach, the root-cause in the process variables causing the KPI deviation is identified based on an impact of the determined order of each substantial process variable, the causal effect, and the causal relation on the plurality of process variables.

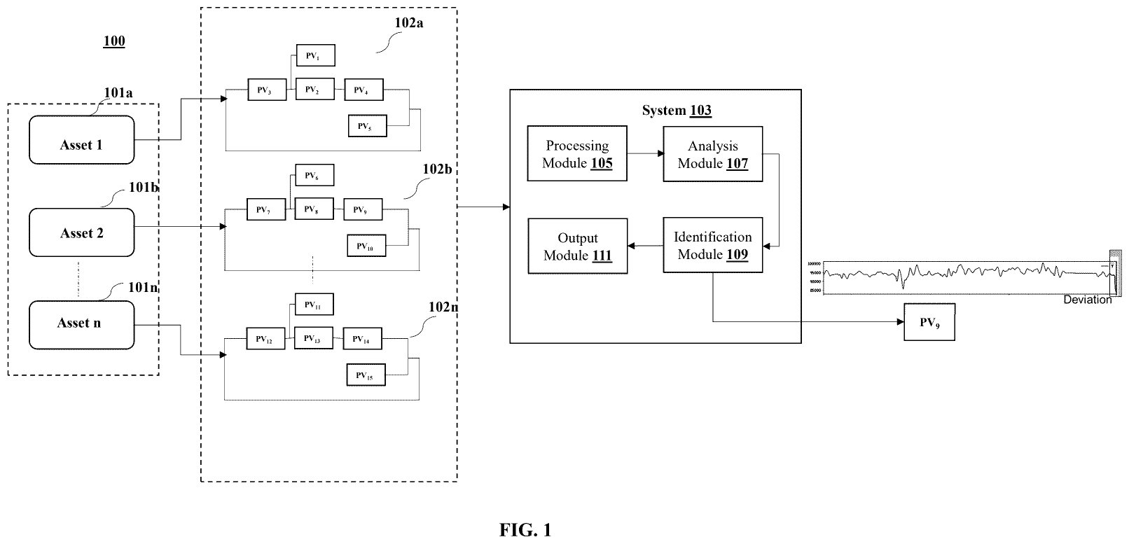

A detailed explanation of each of the above-mentioned operations will be explained in the forthcoming paragraphs through FIGS. 1-13.

FIG. 1 illustrates an example environment of a system 100 for identifying root-cause in process variables causing KPI deviation in an industrial process, according to an embodiment of the present disclosure. According to an embodiment, FIG. 1 depicts an environment 100 that includes a plurality of assets (e.g. asset 1 101a, asset 2 101b, asset 3 101n). The ‘plurality of assets’ may be collectively labeled as ‘101’. Further, the ‘plurality of assets’ may be alternately referred to as ‘assets’ or ‘asset’. As an example, the assets may include transmitters, programmable logic controllers (PLCs), control valves, actuators, PID controllers, and the like.

According to an embodiment, each asset 101 is connected with a plurality of process variables (e.g. 102a, 102b, 102n). The plurality of process variables (e.g. 102a, 102b, 102n) are interconnected with each other and labeled as PV₁, PV₂, . . . , PVₙ. Further, the ‘plurality of process variables’ may be alternately referred to as ‘process variables’ or ‘process variable’. As an example, the process variables may include flow rate, pressure, temperature, viscosity, heat exchange rate, pH value, and the like.

Further, the process variables may be defined as measurable parameters that define the state or condition of the industrial process. The process variables are critical to manage and the performance of the process variables controls the deviation in KPI, since the process variables provide essential information regarding the process performance. Therefore, the process variables play a pivotal role in maintaining optimal operating conditions and thereby, achieving a target KPI performance in the industrial process.

According to an embodiment, each asset 101 forms a part of a control loop associated with the process variable in the industrial process. According to a further non-limiting example, each asset 101 may be operatively coupled with a system 103. In a non-limiting example, the system 103 may be a computer, a laptop, a smartphone, or any electronic machine.

According to an embodiment, each asset 101 acquires process data from one or more process variables (102a, 102b, 102n) associated with one or more assets (101a, 101b, 101c). In a non-limiting example, the process data includes sensor data, control signals, communication signals, pressure signals, data associated with various process variables (102a, 102b, 102n) in the control loop, etc. According to some embodiment, the process data associated with the assets 101 may be stored in a database. The ‘process data’ may be alternately referred to as ‘operational data’ throughout the disclosure. In an embodiment, the process data acquired from one or more process variables is utilized for determining the changed performance characteristics in each asset.

Further, the system 103 includes a processing module 105, an analysis module 107, an identification module 109, and an output module 111. According to an embodiment, the processing module 105, the analysis module 107, the identification module 109, and the output module 111 are operatively coupled with each other. According to one or more embodiments, processing module 105, the analysis module 107, the identification module 109, and the output module 111 are uniquely designed hardware modules or software modules.

According to an embodiment, the processing module 105 monitors assets 101 periodically and acquires the process data. In particular, the processing module 105 reads sensor data from process control loops/units. The process variables include, for example, but are not limited to, temperature, pressure, flow rate, and levels that are being controlled or monitored by the control loops associated with the assets. In an embodiment, the processing module 105, processes the process data to remove outliers, imputing missing data, and computes error data by using state-of-the-art techniques. For example, the outliers can occur due to mode and shutdown conditions. Further, the missing data can occur when the process data is continuously missing for a predefined time period (e.g. 1 hour). Thus, the processing module 105, pre-processes the process data before proceeding further.

According to an embodiment, the analysis module 107 determines changed performance characteristics in each asset among a plurality of assets based on a comparison of expected performance characteristics with respect to a real-time (RT) performance characteristics of each asset. In an embodiment, the analysis module 107 uses Machine Learning models to determine the changed performance characteristics in each asset. Accordingly, the analysis module 107 determines the RT performance characteristics based on the process data by using the ML models. In a non-limiting example, the real-time characteristics include measurements such as temperature, pressure, flow rate, etc., over a given time period. Further, the expected performance characteristics represent the optimal operational performance of each asset with respect to the target KPI. In an embodiment, the expected performance characteristics of each asset are stored in a database. In a non-limiting example, for an industrial process such as a catalytic dehydrogenation process for producing propylene from propane. The process includes various assets such as a heat exchanger, reactor, etc. The analysis module 107 receives the process data from the assets such as a heat exchanger, boiler, etc. Subsequently, the analysis module 107 determines the real-time performance of the assets from the process data. The analysis module 107 compares the real-time performance characteristics of the heat exchanger with the expected performance characteristics using ML models to determine the changed performance characteristics. According to an example embodiment, consider that the RT performance characteristics for the producing propylene is a sine wave, however, the expected performance characteristics should be a cosine wave. Thus, there is a change in performance characteristics which indicates the deviation in the real-time performance characteristics with respect to the expected performance characteristics.

In an embodiment, the analysis module 107 identifies a set of key process variables based on the result of the determination explained above. The analysis module 107 identifies the set of key process variables associated with each asset exhibiting the changed performance characteristics. In an embodiment, one or more key process variables among the set of key process variables may share a similar pattern of the changed performance characteristics. For example, two or more process variables may exhibit a cosine pattern indicating the changed performance characteristics. Accordingly, the analysis module 107 identifies such one or more key process variables with similar patterns of changed performance characteristics and clusters those key process variables to form one or more groups. Therefore, each group of key process variables are representative of key process variables having a similar pattern of changed performance characteristics. The clustering of the key process variables aids in handling multicollinearity such that, two or more key process variables that are highly correlated with each other will be grouped together thereby, retaining a single feature from each group of key process variables. The clustering of the key process variables helps in reducing the dimensionality of the process data.

In an embodiment, the analysis module 107 further selects a set of substantial process variables from the one or more groups of key process variables exhibiting deviated KPI performance with respect to a target KPI performance. The substantial process variables are indicative of key process variables responsible for KPI deviation.

In an implementation, the analysis module 107 performs a distance-based co-relation analysis on the real-time performance characteristics of each key process variable in each group with respect to the target KPI performance. Further, based on the distance-based co-relation analysis, the analysis module 107 selects from each one or more groups, a set of substantial process variables exhibiting deviated KPI performance with respect to a target KPI performance. In an embodiment, the distance-based co-relation analysis determines a degree of similarity in the real-time performance characteristics of each key process variable with respect to the target KPI performance. For example, in the production process of propylene, the analysis module 107 identifies how much the real-time performance characteristics such as flow rate is deviated from the expected performance characteristics resulting in deviation in the target KPIs performance such as deviation in efficiency due to change in flow rate. Based on the determined degree of similarity, a set of substantial process variables is selected from the group of key process variables. This further reduces the dimensionality of the process data. In an embodiment, the degree of similarity indicates a degree by which the real-time performance characteristics of each key process variables are deviated with respect to the target KPI performance. The target KPI performance represents the desired or expected performance level in the industrial process. The target KPI performance may be set based on historical data, industry standards, or specific operational goals.

In an embodiment, the analysis module 107 further determines a causal effect and causal relation between each substantial process variable in the set of substantial process variables so as to determine an impact of each substantial process variable on other process variables. In an embodiment, the analysis module 107 performs a casualty analysis on each substantial process variable. In an embodiment, the analysis module 107 determines a causal effect and a causal relation between each substantial process variable based on the casualty analysis. In an implementation, the set of substantial process variables is assigned contribution weights on the basis of the degree of similarity using ML models. Further, on the basis of the contribution weight, a rank is assigned to each substantial process variable. The degree of similarity, determined during the distance-based co-relation analysis, forms the basis for assigning contribution weights. In an embodiment, the substantial process variables with a higher degree of similarity (lower distance) with the target KPI are assigned higher contribution weights, indicating a stronger contribution to the KPI deviation.

For example, in the production process of propylene from propene, consider that the substantial process variables such as temperature and flow rate have a higher degree of similarity with efficiency and substantial process variables such as pressure have a lower degree of similarity with efficiency. Thus, the analysis module 107, assigns a higher contribution weight to temperature and flow rate indicating a stronger contribution to the KPI deviation. Further, the analysis module 107 assigns a higher rank to temperature and flow rate and a lower rank to pressure with respect to deviation in efficiency. In an embodiment, ML models are used to calculate the contribution weights. The ML models analyze historical and real-time performance characteristics to identify the impact of each substantial process variable on the KPI deviation. Accordingly, the analysis module 107 determines the causal relation and the causal effect between each substantial process variable based on the ranking of the substantial process variable. The causal effect allows for accurate and reliable predictions of root cause process variables responsible for KPI deviation. In an embodiment, the contribution weight indicates the extent to which each substantial process variable contributes to the KPI deviation.

In an embodiment, the analysis module 107 further determines an order of each substantial process variable causing the KPI deviation using a knowledge graph. According to an embodiment, the knowledge graph is a structured representation of at least one interconnection between the assets, a relationship between the assets, attributes shares between the assets, and a hierarchy between the assets. For example, in the production process of propylene from propene, the nodes of the knowledge graph are represented by the assets, the substantial process variables, and the target KPIs. The edges of the knowledge graph represent the relationships between the assets and the substantial process variables. Thus, the impact of the substantial process variables on the target KPIs can be easily envisaged from the knowledge graph. This step provides another level of sorting to define the final ranking of the potential root cause process variables causing KPI deviation. This is done to accommodate the dynamic nature of the industrial process for attaining accurate results. In an embodiment, the knowledge graph is stored in the database.

In an embodiment, an identification module 109 identifies the root-cause in the process variables causing the KPI deviation. Such identification is based on the impact of the determined order of each substantial process variable, the causal effect, and the causal relation on the substantial process variables. For example, the substantial process variable having the highest order represents having the highest impact in causing the KPI deviation on other process variables. Similarly, the substantial process variable having the lowest order represents having the lowest impact in causing the KPI deviation on other process variables.

In an embodiment, an output module 111 generates a report. In an embodiment, the report includes the one or more root-cause process variables causing KPI deviation, a detailed analysis of the KPI deviation, and the root causes associated with it. Further, the output module 111 may be coupled with a display to display the report.

In some embodiment, a performance analytics platform may be implemented in the system 100 that facilitates visualization, reporting, and integration with control systems for identifying root-cause process variables for KPI deviation.

According to some embodiments, functions of the processing module 105, the analysis module 107, the identification module 109, and the output module 111 can be performed by a processor(s). Further, according to some embodiment, the processing module 105, the analysis module 107, the identification module 109, and the output module 111 are integrated with the performance analytics platform. Further, the labels depicted in the representative drawings are kept the same for similar components throughout the disclosure for ease of understanding. A brief explanation of each of the modules as depicted in FIG. 1 will be explained in the forthcoming paragraphs.

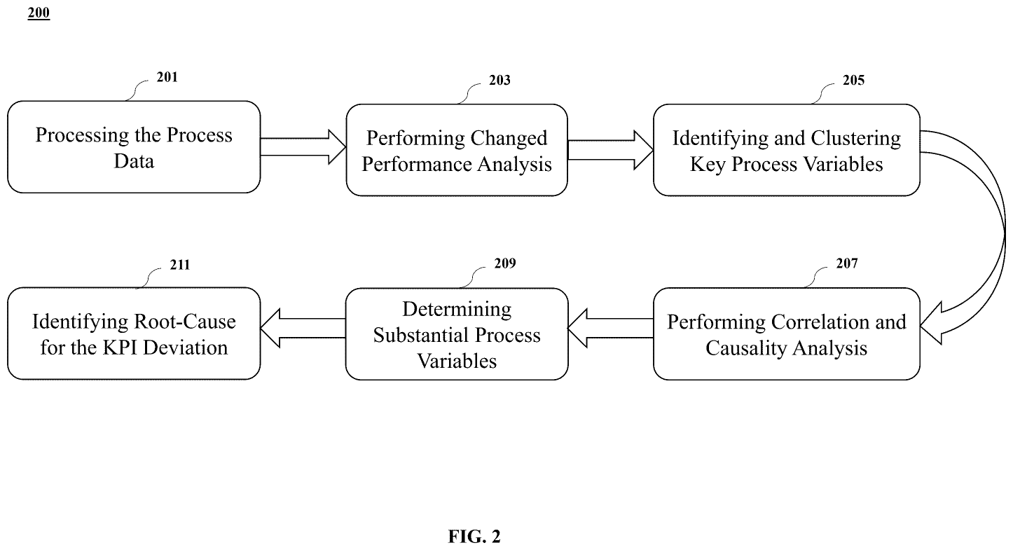

FIG. 2 illustrates a general operational flow 200 for identifying root-cause in process variables causing KPI deviation in an industrial process, according to an embodiment of the present disclosure. According to an embodiment, method 200 is implemented in the system 103. A brief explanation of the operational flow 200 will be explained by referring to FIG. 1 in the forthcoming paragraphs.

According to an embodiment, the operation 201 is implemented with the processing module 105. In an embodiment, at operation 201, the process data is provided as an input for processing. In an embodiment, at operation 201, the process data is pre-processed. Further, any outliers, missing data, and error in the process data are detected and removed from the operational data. Further, in a case, when the process data is not in a standard format then, the process data is transformed. Accordingly, the operation 201, outputs the processed data.

According to a further embodiment, operation 203 is implemented with the analysis module 107. In an embodiment, the processed data obtained at operation 201 is provided as input to the analysis module 107. According to an embodiment, at operation 203, the processed data is analyzed by Machine Learning (ML) models to determine the changed performance characteristics in each asset among the plurality of assets based on a comparison of the expected performance characteristics with respect to the real-time performance characteristics of each asset. Accordingly, the operation 203, outputs the set of assets with changed performance characteristics.

According to an embodiment, operation 205 is implemented with the analysis module 107. In an embodiment, the set of assets with changed performance characteristics is taken as input at operation 205. In an embodiment, at operation 205, the one or more key process variables associated with each asset, exhibiting the changed performance characteristics are identified. In an embodiment, the operation 205 further clusters one or more key process variables comprised in each group of process variables that share the similar pattern of changed performance characteristics to form the group of key process variables. Accordingly, the operation 205, outputs the groups of key process variables.

According to a further embodiment, operation 207 is implemented with the analysis module 107. In an embodiment, the groups of key process variables are taken as input, and a correlation analysis is performed on each group of key process variables to obtain the set of substantial process variables (as shown in operation 209) exhibiting deviated KPI performance with respect to the target KPI performance. According to an embodiment, at operation 207, the set of substantial process variables are assigned contribution weights on the basis of the degree of similarity. Further, at operation 207, on the basis of the contribution weight, the rank is assigned to each substantial process variable. Furthermore, at operation 207, the causal relation and the causal effect between each substantial process variable are determined based on the ranking of the substantial process variable. Further, the order of each substantial process variable causing the KPI deviation is determined based on the knowledge graph.

According to an embodiment, operation 211 is implemented with the identification module 109. In an embodiment, at operation 211, the root-cause in the process variables causing the KPI deviation is identified based on the impact of the determined order of each substantial process variable, the causal effect, and the causal relation on the process variables.

The forthcoming paragraphs describe each operation of FIG. 2 in detail.

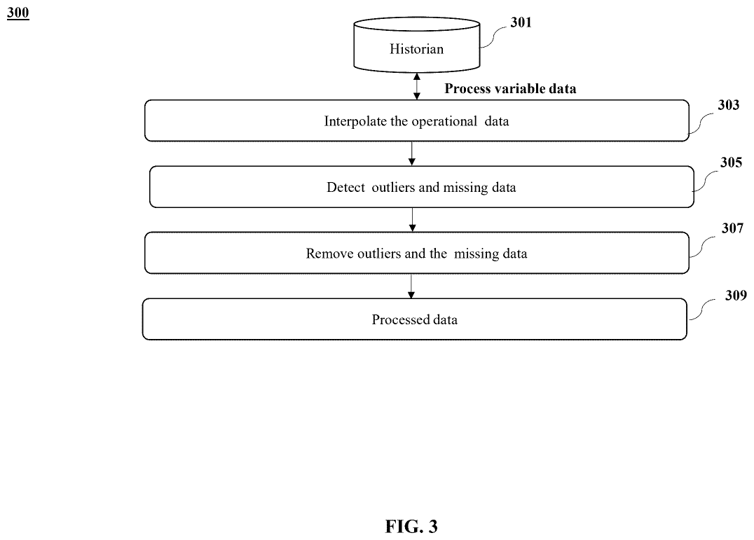

FIG. 3 illustrates a method flow 300 of processing the process data, according to an embodiment of the present disclosure. According to an embodiment, method 300 depicts operation 201 of FIG. 2 for processing the operational data.

In an embodiment, as explained above the processing module 105 reads sensor data from process control loops/units, which is further stored in the database as a historian 301. The historian 301 indicates historical data stored in the database. Further, at operation 303, the processing module 105 interpolates the operational data. Further, at operation 305, the processing module 105 detects at least one of the outliers and the missing data. As an example, the outliers can occur due to mode and shutdown conditions. Accordingly, when the mode and shutdown conditions occur in system 103, the processing module 105 detects the outliers. As a further example, for detecting the missing data, the processing module 105 monitors whether the process data is continuously missing for the predefined time period. Accordingly, if the processing module 105 determines that the process data, that is continuously missing, is less than the predefined time period, then the process data is imputed. On the other hand, if the system determines that the process data that is continuously missing is more than the predefined time period then the process data is removed. Thus, at operation 307, the processing module 105 removes the at least one of the outliers and missing data from the process data based on the result of the detection. Accordingly, the processing module 105 generates processed data, at operation 309, after performing operations 303 to operations 309.

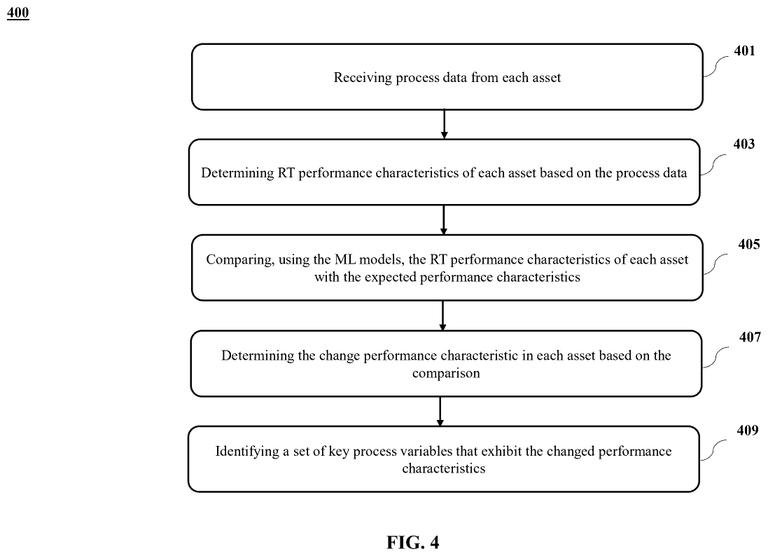

FIG. 4 illustrates a method flow for identifying the set of key process variables that exhibit the changed performance characteristics by the analysis module 107, according to an embodiment of the present disclosure. According to an embodiment, method 400 depicts the operation 203 of FIG. 2 for performing changed performance analysis associated with each asset.

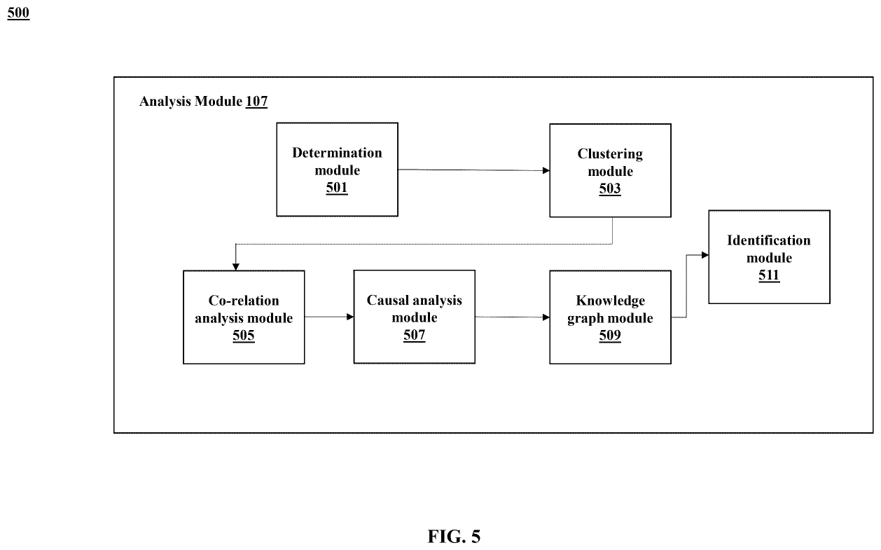

FIG. 5 illustrates an example block diagram of the analysis module 107, in accordance with an embodiment of the present disclosure. According to an embodiment, the analysis module 107 includes a determination module 501, a clustering module 503, a co-relation analysis module 505, a causal analysis module 507, a knowledge graph module 509, and an identification module 511. According to an embodiment, the determination module 501, the clustering module 503, the co-relation analysis module 505, the causal analysis module 507, the knowledge graph module 509, and the identification module 511 are operatively coupled with each other. According to one or more embodiments, the determination module 501, the clustering module 503, the co-relation analysis module 505, the causal analysis module 507, the knowledge graph module 509, and the identification module 511 are uniquely designed hardware modules or software modules. The operation of analysis module 107 will be explained through the various modules as depicted in FIG. 5 in the forthcoming paragraphs.

According to an embodiment, at operation 401, the analysis module 107, receives the process data from each asset where each asset is connected to a large number of process variables. For example, consider an industrial plant with four key assets: a boiler, a heat exchanger, a reactor, and a pump. Each asset has several process variables (referred to as PVs) associated with it:
Boiler (Asset 1): Temperature (PV₁), Pressure (PV₂), Flow Rate (PV₃), Fuel Consumption (PV₄)
Heat Exchanger (Asset 2): Inlet Temperature (PV₅), Outlet Temperature (PV₆), Flow Rate (PV₇), Heat Transfer Coefficient (PV₈)
Reactor (Asset 3): Temperature (PV₉), Pressure (PV₁₀), Flow Rate (PV₁₁), pH Level (PV₁₂), Viscosity (PV₁₃), Reaction Rate (PV₁₄), Catalyst Concentration (PV₁₅), Conversion Rate (PV₁₆)
Pump (Asset 4): Inlet Pressure (PV₁₇), Outlet Pressure (PV₁₈), Flow Rate (PV₁₉), Power Consumption (PV₂₀)

Further, the processing module 105 collects real-time process data from the assets, such as:
PV₁: 180° C.
PV₂: 15 bar
PV₃: 500 L/min
PV₄: 95 L/h
PV₅: 148° C.
PV₆: 130° C.
PV₇: 450 L/min
PV₈: 480 W/m²K
PV₉: 198° C.
PV₁₀: 20 bar
PV₁₁: 610 L/min
PV₁₂: 7
PV₁₃: 10 cP
PV₁₄: 96%
PV₁₅: 0.48 mol/L
PV₁₆: 94%
PV₁₇: 2 bar
PV₁₈: 10.2 bar
PV₁₉: 700 L/min
PV₂₀: 48 kW

Further, at operation 403, the determination module 501, determines the real-time performance characteristics of each asset based on the real-time process data. This involves assessing the current state of each process variable to obtain the real-time performance characteristics.

Further, at operation 405, the determination module 501 determines changed performance characteristics in each asset based on the comparison of the expected performance characteristics with respect to the real-time performance characteristics of each asset. In an embodiment, the changed performance characteristics in each asset can be determined based on the ML model. For example, the ML model can be a supervised, semi-supervised, or an unsupervised Algorithmic Agent.

In a non-limiting example, the Supervised Algorithmic Agent may use a Regularized Regression Model to analyze the relationship between the expected performance characteristics and real-time performance characteristics of each asset in the industrial process. Further, the Supervised Algorithmic Agent performs the following steps to identify the changed performance characteristics in each asset:
Data Collection: Historical process data and corresponding performance metrics (expected performance characteristics) are collected. For example, the expected performance characteristics (based on historical data) for the above assets are as follows:
PV₁: 175° C.
PV₂: 14.5 bar
PV₃: 520 L/min
PV₄: 95 L/h
PV₅: 148° C.
PV₆: 132° C.
PV₇: 460 L/min
PV₈: 480 W/m²K
PV₉: 198° C.
PV₁₀: 19.5 bar
PV₁₁: 610 L/min
PV₁₂: 6.9
PV₁₃: 10.5 cP
PV₁₄: 96%
PV₁₅: 0.48 mol/L
PV₁₆: 94%
PV₁₇: 2.1 bar
PV₁₈: 10.2 bar
PV₁₉: 710 L/min
PV₂₀: 48 kW
Model Training: The Regularized Regression Model (such as Lasso or Ridge Regression) is trained using the historical data to learn the relationship between the inputs (process variables) and the output (expected performance characteristics).
Real-Time Analysis: In real-time, the model compares the expected performance characteristics with the real-time performance characteristics to determine the changed performance characteristics. For example, for the above scenario:
PV₁: 180° C. (expected 175° C.)—deviation detected
PV₂: 15 bar (expected 14.5 bar)—deviation detected
PV₃: 500 L/min (expected 520 L/min)—deviation detected
PV₄: 95 L/h (expected 95 L/h)—no deviation detected
PV₅: 148° C. (expected 148° C.)—no deviation detected
PV₆: 130° C. (expected 132° C.)—deviation detected
PV₇: 450 L/min (expected 460 L/min)—deviation detected
PV₈: 480 W/m²K (expected 480 W/m²K)—no deviation detected
PV₉: 198° C. (expected 198° C.)—no deviation detected
PV₁₀: 20 bar (expected 19.5 bar)—slight deviation detected
PV₁₁: 610 L/min (expected 610 L/min)—no deviation detected
PV₁₂: 7 (expected 6.9)—slight deviation detected
PV₁₃: 10 cP (expected 10.5 cP)—deviation detected
PV₁₄: 96% (expected 96%)—no deviation detected
PV₁₅: 0.48 mol/L (expected 0.48 mol/L)—no deviation detected
PV₁₆: 94% (expected 94%)—no deviation detected
PV₁₇: 2 bar (expected 2.1 bar)—slight deviation detected
PV₁₈: 10.2 bar (expected 10.2 bar)—no deviation detected
PV₁₉: 700 L/min (expected 710 L/min)—deviation detected
PV₂₀: 48 kW (expected 48 kW)—no deviation detected
   Accordingly, based on the comparison, the ML model identifies deviations as below:
Boiler (Asset 1): Temperature (PV₁), Pressure (PV₂), and Flow Rate (PV₃) deviations
Heat Exchanger (Asset 2): Outlet Temperature (PV₆), and Flow Rate (PV₇) deviations
Reactor (Asset 3): Pressure (PV₁₀), pH Level (PV₁₂), and Viscosity (PV₁₃) deviations
Pump (Asset 4): Inlet Pressure (PV₁₇), and Flow Rate (PV₁₉) deviations

In a further non-limiting example, the determination module 501 may use the Semi-Supervised Agent to determine the changed performance characteristics in each asset. The Semi-Supervised Agent may utilize Principal Component Analysis (PCA) to find a co-relation between the process variables associated with each asset. Further, the PCA extrapolates the correlated process variables associated with each asset in sets of uncorrelated process variables (principal components) associated with each asset. Furthermore, the PCA finds a deviation in the principal components such that, the deviation in the principal components indicates anomalies in the performance characteristics.

In yet another non-limiting example, the determination module 501 utilizes the Data Drift Agent model to identify root-cause in process variables causing KPI deviation. The Data Drift Agent Model defines statistical distance measures between the expected performance characteristics and the real-time performance characteristics. Further, the expected performance characteristics of each asset are taken as a reference distribution such that, the real-time performance characteristics of each asset are compared against the reference distribution. As a result, at operation 407, the changed performance characteristics of each asset can be obtained.

According to an embodiment, at operation 409, the determination module 501 identifies a set of key process variables associated with each asset based on the determination of the changed performance characteristics of each asset. The identified key process variables include one or more key process variables that exhibit the changed performance characteristics. According to the above example, consider that the set of key proves variables are obtained as PV₁, PV₂, PV₃, PV₆, PV₇, PV₁₀, PV₁₂, PV₁₃, PV₁₇, PV₁₉.

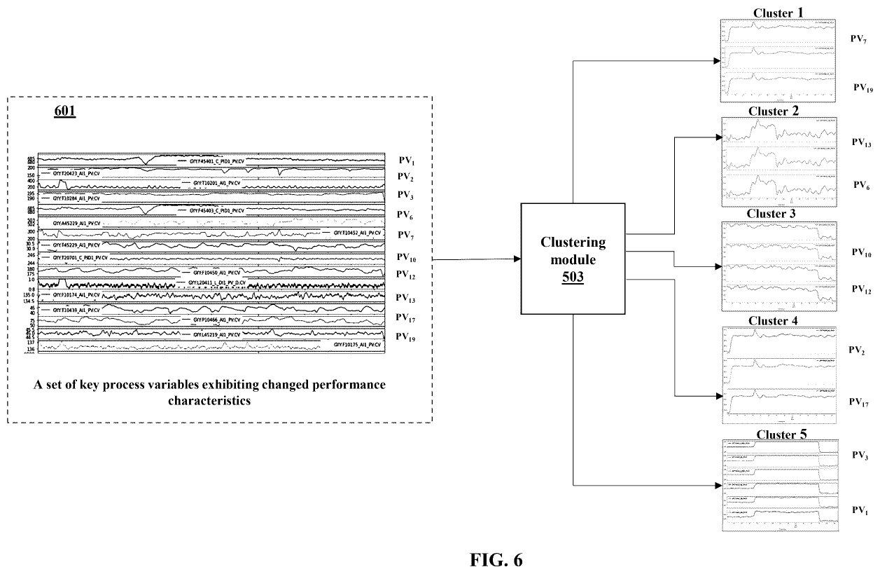

FIG. 6 illustrates an example of clustering of the key process data, according to an embodiment of the present disclosure. According to an embodiment, the clustering of the key process data is performed by the clustering module 503. In a non-limiting example, the clustering can be performed by using an ML model such as agglomerative or divisive hierarchical clustering. According to an example embodiment, block 601 illustrates the set of key process variables exhibiting changed performance characteristics obtained from the previous steps explained above. As shown, in a non-limiting example, block 601 illustrates the changed performance characteristics of process variables PV₁, PV₂, PV₃, PV₆, PV₇, PV₁₀, PV₁₂, PV₁₃, PV₁₇, PV₁₉. Further, the clustering module 205 analyzes the changed performance characteristics of the key process variables PV₁, PV₂, PV₃, PV₆, PV₇, PV₁₀, PV₁₂, PV₁₃, PV₁₇, and PV₁₉. Based on the analysis, the clustering module 503 forms groups or clusters of one or more key process variables exhibiting a similar pattern of the changed performance. In a non-limiting example, clustering module 503 forms five clusters 1, 2, 3, 4, and 5 of key process variables, each cluster includes one or more key process variables showing a similar pattern of changed performance variables.

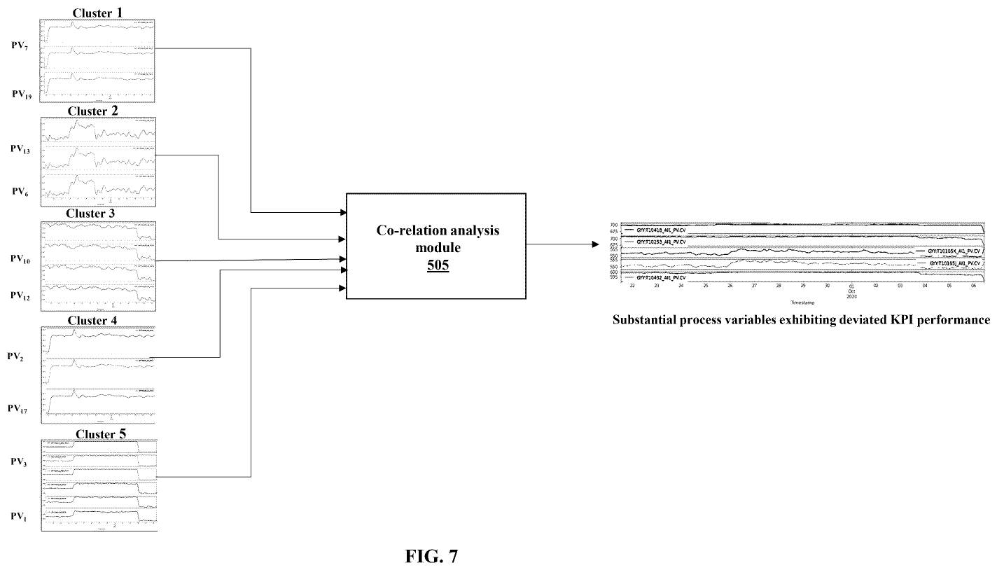

FIG. 7 illustrates an example of co-relation analysis, according to an embodiment of the present disclosure. According to an example, the co-relation analysis is implemented in the co-relation analysis module 505. In a non-limiting example, clusters 1, 2, 3, 4, and 5 of the key process variables exhibiting the similar pattern of the changed performance characteristics are given as input to the co-relation analysis module 505. Further, the co-relation analysis module 505 performs the distance-based co-relation analysis on the real-time performance characteristics of each key process variable with respect to the target KPI performance. Further, the co-relation analysis module 505 determines the degree of similarity in the real-time performance characteristics of each key process variable with respect to the target KPI performance. The degree of similarity indicates the degree by which the real-time performance characteristics of each key process variable are deviated with respect to the target KPI performance. Accordingly, the co-relation analysis module 505 selects the set of substantial process variables PV₁, PV₂, PV₇, PV₁₂ and PV₁₃ from each cluster based on the degree of similarity.

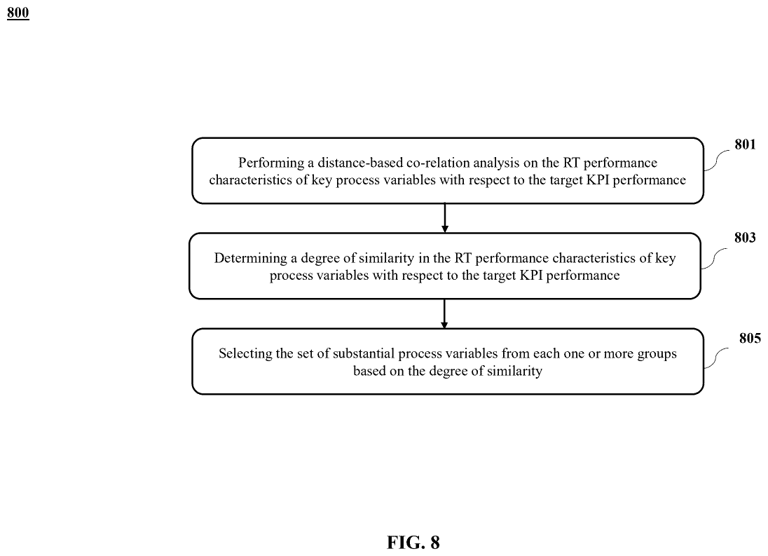

FIG. 8 illustrates a method flow for selecting the set of substantial process variables from each group of key process variables exhibiting the similar pattern of the changed performance characteristics, according to an embodiment of the present disclosure. According to an embodiment, the co-relation analysis is performed by the co-relation analysis module 505 for selecting the set of substantial process variables. According to an embodiment, method 800 depicts the operation 207 of FIG. 7 for co-relation analysis.

According to an embodiment, method 800 depicts an operation 801 for selecting the set of substantial process variables from each group of key process variables. In an embodiment, the co-relation analysis module 505 performs the distance-based co-relation analysis on the real-time performance characteristics of the key process variables with respect to the target KPI performance. The distance-based correlation analysis involves calculating the distance between the real-time performance characteristics of each key process variable and the target KPI performance. This distance quantifies how much the real-time performance characteristics deviate from the target KPI performance. The real-time performance data of each key process variable is compared with the target KPI performance. Various distance metrics, such as Euclidean distance, Manhattan distance, or Mahalanobis distance, can be used to quantify the degree of deviation.

In an embodiment, at operation 803, the co-relation analysis module 505 determines the degree of similarity between the real-time performance characteristics of each key process variable and the target KPI performance based on the calculated distances obtained from one of the distance metrics. A lower distance indicates a higher degree of similarity, which in turn indicates that the key process variable's performance is closer to the target KPI performance. The co-relation analysis module 505 selects the substantial process variables PV₁, PV₂, PV₇, PV₁₂, and PV₁₃ from the set of key process variables based on their degree of similarity.

In an embodiment, at operation 805, the co-relation analysis module 505 identifies the key process variables with the smallest distances (highest degree of similarity) as substantial process variables as they exhibit the most significant deviations affecting the KPI performance.

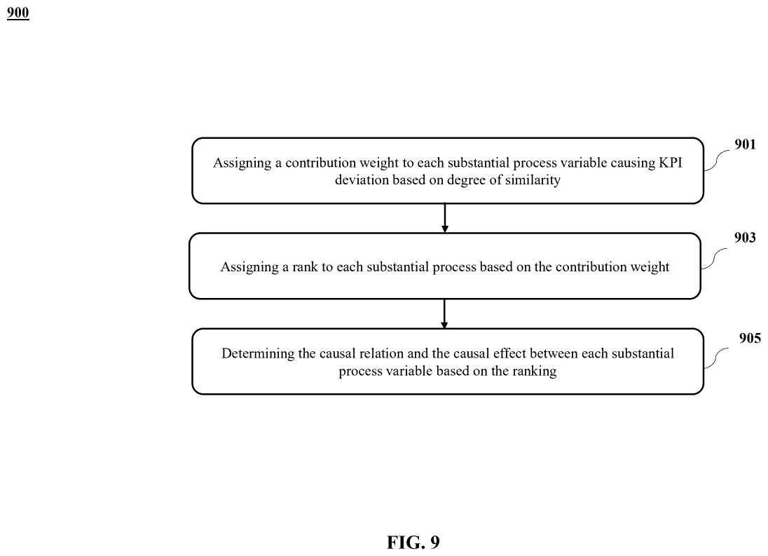

FIG. 9 illustrates a method flow of causality analysis, according to an embodiment of the present disclosure. According to an embodiment, the causality analysis is performed by the causal analysis module 507.

According to an embodiment, at operation 901, the causal analysis module 507 assigns a contribution weight to each substantial process variable. The contribution weight indicates the extent to which each substantial process variable contributes to the KPI deviation In an embodiment, at operation 901, the degree of similarity, determined during the distance-based co-relation analysis, forms the basis for assigning contribution weights. The substantial process variables with higher degrees of similarity (lower distance) are assigned higher contribution weights, indicating a stronger contribution to the KPI deviation. In an embodiment, ML models are used to calculate the contribution weights. The ML models analyze historical and real-time performance characteristics to identify the impact of each substantial process variable on the KPI deviation.

According to an embodiment, at operation 903, the causal analysis module 507 assigns rank to each substantial process based on the contribution weight. In particular, the operation 903 includes combining the substantial process variables by adding the contribution weights of each substantial process variable. Further, the causal analysis module 507 applies a causal inferencing method such as Meta learners and Linear double ML (DML) methods to rank the substantial process variables based on their impact on the KPI deviation. The substantial process variables with higher causal effects are ranked higher, signifying a greater impact on the KPI deviation. In an embodiment, the causal analysis module 507 ranks the substantial process variables PV₁, PV₂, PV₇, PV₁₂, and PV₁₃ in the following order, starting from highest to the lowest:
1. PV₁
2. PV₂
3. PV₁₃
4. PV₇
5. PV₁₂

In general, the Meta Learners are ML models designed to estimate causal effects by leveraging predictive models. Meta Learners use a two-step approach: first, the Meta Learners model the outcome variable (KPI deviation) and the treatment (or intervention) variable (substantial process variables), and then the Meta Learners estimate the causal effect between the two. The first step predicts the outcome (KPI deviation) based on the features (process variables). Simultaneously, another model predicts the treatment variable, which is the substantial process variable under analysis. In the second step, the predicted values from the first model are used to estimate the causal effect of the treatment on the outcome. The causal effects estimated for each substantial process variable are then used to rank these process variables. Process variables with higher estimated effects are ranked higher, indicating a more significant impact on the KPI deviation. For example, in an embodiment, substantial process variables PV₁, PV₂, PV₁₃ are ranked higher than PV₇, PV₁₂.

According to an embodiment, at operation 905, the causal analysis module 507 determines the causal relation and the causal effect between each substantial process variable based on the ranking. The causal analysis module 507 further determines the sequence of causal relationships leading to the KPI deviation based on the ranking.

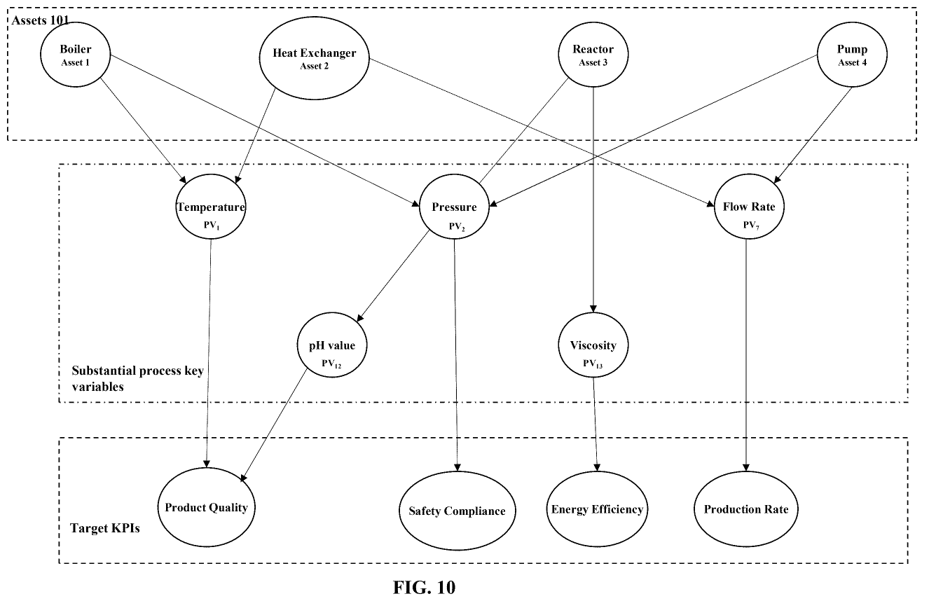

FIG. 10 illustrates a non-limiting example of a knowledge graph of an industrial process. According to an embodiment, the knowledge graph is the structured representation of at least one of the interconnection between the plurality of the assets, the relationship between the plurality of the assets, attributes shares between the plurality of the assets, and the hierarchy between the plurality of the assets.

As shown in the figure, the nodes of the knowledge graph are represented by the assets, the substantial process variables, and the target KPIs. Further, in a non-limiting example, the assets of the industrial process may include the boiler (Asset 1), the heat exchanger (Asset 2), the reactor (Asset 3), and the pump (Asset 4). Further, the identified substantial process variables from previous steps may include temperature PV₁, pressure PV₂, flow rate PV₇, pH value PV₁₂, and viscosity PV₁₃ associated with the assets. The target KPIs of this industrial process may include product quality, energy efficiency, production rate, and safety compliance. As shown, the arrows depict an interconnection between the assets, substantial process variables, and the target KPIs. Accordingly, the edges of the knowledge graph define the relationships between the assets and the substantial process variables. As shown in FIG. 10, the boiler controls both the temperature and pressure in the industrial process, hence, edges are drawn from the boiler node to the temperature and pressure nodes. Similarly, the heat exchanger affects the temperature and the flow rate of the fluid, hence, the edges connect the heat exchanger node to the temperature and flow rate nodes. Further, the reactor influences the chemical properties of the industrial process, such as pH level and viscosity. Thus, edges link the reactor node to the pH level and viscosity nodes. Furthermore, the pump affects both the flow rate and pressure within the industrial process, indicated by edges from the pump node to the flow rate and pressure nodes. The knowledge graph is utilized to enhance the accuracy and reliability of the determining the root-cause in process variables causing KPI deviation.

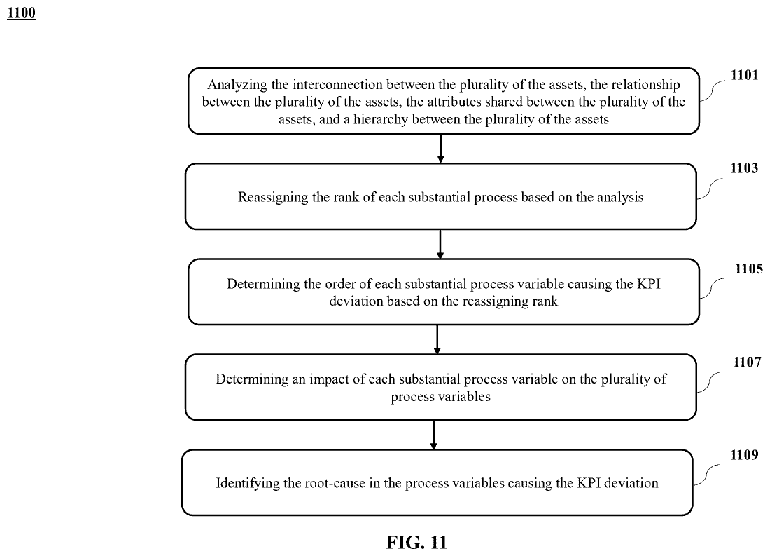

FIG. 11 illustrates a method flow for identifying the root-cause in the process variables causing the KPI deviation using the knowledge graph analysis, according to an embodiment of the present disclosure. According to an embodiment, the method 1100 is implemented in the analysis module 107 and the identification module 109. The method 1100 corresponds to operations 209 and 211 of FIG. 2.

According to an embodiment, at operation 1101, the analysis module 107 analyses the knowledge graph. In particular, the analysis module 107 analyses the interconnection between the plurality of the assets, the relationship between the plurality of the assets, the attributes shared between the plurality of the assets, and the hierarchy between the plurality of the assets.

According to an embodiment, at operation 1103, based on the analysis of the knowledge graph,, the ranks of one or more substantial processes are reassigned. For example, in an embodiment, the knowledge graph module 509 reassigns the previously determined ranks in the following order, starting from highest to the lowest:
1. PV₁
2. PV₂
3. PV₇
4. PV₁₃
5. PV₁₂
   In an embodiment, at operation 1105, the analysis module 107 determines an order based on the reassigned rankings of the substantial process variables causing KPI deviation. Further, at operation 1107, the identification module 109 identifies the impact of the determined order of each substantial process variable on the KPI deviation. According to an embodiment, at operation 1109, the identification module 109 identifies the root-cause in the process variable causing the KPI deviation is identified based on the impact of each substantial process variable on the KPI deviation. The identification module 109 further considers the causal effect and the causal relation on the plurality of process variables. For example, referring to FIG. 10, if there is a deviation in the product quality KPI, the substantial process variables for example PV₂ having a relationship with the product quality KPI, like temperature and pH level will be considered. Accordingly, the identification module 109 will trace these substantial process variables back to the assets (Boiler, Reactor) that influence them to take corrective measures.

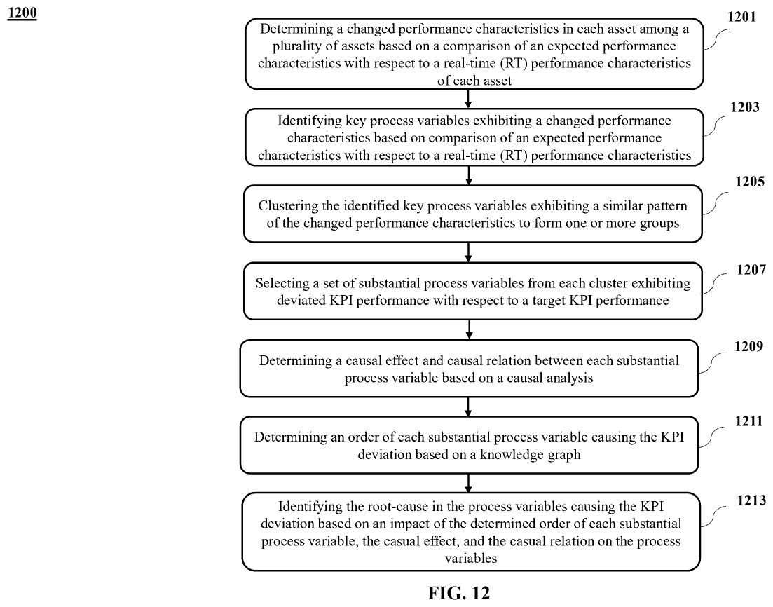

FIG. 12 illustrates identifying root-cause in process variables causing KPI deviation, in accordance with an embodiment of the present disclosure. The method 1200 is implemented in the system 103 of FIGS. 1 and 2. According to an embodiment, the method 1200 may be implemented with the processor(s), and various modules. An explanation of the various modules is explained through FIGS. 1-11, therefore detailed explanation of the same is omitted here for the sake of brevity.

According to an embodiment of the present disclosure, at operation 1201, the method 1200 includes determining, using ML models, the changed performance characteristics in each asset among a plurality of assets based on the comparison of the expected performance characteristics with respect to the real-time performance characteristics of each asset. According to an embodiment for determining the changed performance characteristic in each asset, the operation 1201 includes, receiving process data from each asset. Further, the operation includes determining RT performance characteristics of each asset based on the process data. Further, the operation 1201 includes comparing, using the ML models, the RT performance characteristics of each asset with the expected performance characteristics. Based on the comparison, the operation 1201 includes determining the changed performance characteristic in each asset.

The method 1200 further includes, at operation 1203, identifying, based on the result of the determination, the set of key process variables, from the plurality of process variables associated with each asset. The set of key process variables includes one or more key process variables that exhibit the changed performance characteristics.

In an implementation, the operation at 1203 is implemented in the analysis module 107.

Further, at operation 1205, the method 1200 includes, clustering the one or more key process variables exhibiting the similar pattern of the changed performance characteristics to form one or more groups.

In an embodiment, at operation 1207, the distance-based co-relation analysis real-time performance characteristics of each key process variables in the one or more groups with respect to the target KPI performance. Further, at operation 1207, the set of substantial process variables exhibiting deviated KPI performance with respect to the target KPI performance are selected from one or more groups of key process variables based on such co-relation analysis. Further, at operation 1207, performing the co-relation analysis on the real-time performance characteristics of each key process variable is based on the determination of the degree of similarity in the real-time performance characteristics of each key process variable with respect to the target KPI performance. Further, at operation 1207, the set of substantial process variables from each group is selected based on the degree of similarity. The operations related to the co-relation analysis are performed by the co-relation analysis module 505 in accordance with FIG. 7.

According to an embodiment, at operation 1209, for determining the causal effect and causal relation between each substantial process variable based on the causal analysis. The causal analysis includes assigning contribution weight to each substantial process variable. The degree of similarity, determined during the distance-based correlation analysis, forms the basis for assigning contribution weights. The substantial process variables with higher degrees of similarity (lower distance) are assigned higher contribution weights, indicating the stronger contribution to the KPI deviation. In some embodiments, ML models are used to calculate the contribution weights. A detailed explanation of the causal analysis is explained by referring to operations related to the analysis module 107.

In an embodiment, after performing the causal analysis to determine the ranking of substantial process variables, at operation 1211, the method 1200 includes determining the assets associated with the ranked substantial process variables are determined. Further, at operation 1211, based on the knowledge graph, the interconnection between the assets, the relationship between the assets, the attributes shared between the assets, and the hierarchy between the assets is analyzed. The knowledge graph is utilized after performing the causal analysis on the substantial process variables to enhance the accuracy and reliability of the root cause for KPI deviation. Further, at operation 1211, based on the knowledge graph analysis, the rankings assigned as a result of the causal analysis are re-evaluated and the ranks of each substantial process are reassigned. Further, at operation 1211, based on the reassigned rankings of the substantial process variables causing KPI deviation, the order is determined. The order signifies the impact of each substantial process variable on the KPI deviation. A detailed explanation of the operation 1211 can be referred to through the operation related to the analysis module 107 and FIG. 11.

According to a further embodiment, at operation 1213, the method 1200 includes identifying the root-cause in the process variables causing the KPI deviation based on the impact of the determined order of each substantial process variable, the casual effect, and the casual relation on the process variables.

The disclosed techniques improve the overall process performance and production efficiency. More particularly, the present disclosure discloses the automated method for identifying root-cause in process variables causing KPI deviation in the industrial process. The root-cause diagnosis identifies the core cause loop(s)/unit(s) that, if addressed, can prevent the occurrence and propagation of KPI deviation in the control loops, units, and plant-wide systems.

The disclosed system and method improve overall process performance and production efficiency by efficiently identifying the root-cause in process variables causing the KPI deviation and addressing associated issues. The system further enhances operational efficiency, mitigates safety risks, and minimizes production losses and costs.

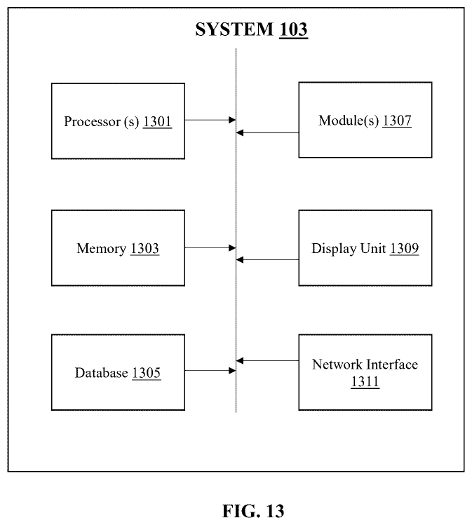

FIG. 13 illustrates a general block diagram of the system, according to an embodiment of the present disclosure.

In an example, the processor(s) 1301 may be a single processing unit or a number of units, all of which could include multiple computing units. The processor(s) 1301 may be implemented as one or more microprocessors, microcomputers, microcontrollers, digital signal processors, central processing units, logical processors, virtual processors, state machines, logic circuitries, and/or any devices that manipulate signals based on operational instructions. Among other capabilities, the processor(s) 1301 is configured to fetch and execute computer-readable instructions and data stored in the memory 1303.

The memory 1303 may include any non-transitory computer-readable medium known in the art including, for example, volatile memory, such as static random access memory (SRAM) and dynamic random access memory (DRAM), and/or non-volatile memory, such as read-only memory (ROM), erasable programmable ROM, flash memories, hard disks, optical disks, and magnetic tapes.

In an example, the module(s), engine(s), and/or unit(s) 1507 may include a program, a subroutine, a portion of a program, a software component or a hardware component capable of performing a stated task or function. As used herein, the module(s), engine(s), and/or unit(s) may be implemented on a hardware component such as a server independently of other modules, or a module can exist with other modules on the same server, or within the same program. The module(s), engine(s), and/or unit(s) 1503 may be implemented on a hardware component such as processor one or more microprocessors, microcomputers, microcontrollers, digital signal processors, central processing units, state machines, logic circuitries, and/or any devices that manipulate signals based on operational instructions. The module(s), engine(s), and/or unit(s) 1303 when executed by the processor(s) 1301 may be configured to perform any of the described functionalities. According to an embodiment, the module 1303 includes the processing module 105, the analysis module 107, the identification module 109, and the output module 111. In an alternate embodiment, the functions of the aforesaid modules may be performed by the processor(s) 1301.

As a further example, the database 1305 may be implemented with integrated hardware and software. The hardware may include a hardware disk controller with programmable search capabilities or a software system running on general-purpose hardware. Examples of databases are but are not limited to, in-memory databases, cloud databases, distributed databases, embedded databases, and the like. The database amongst other things, serves as a repository for storing data processed, received, and generated by one or more of the processor(s) 1301, and the modules/engines/units 1305.

The modules/engines/units 1305 may be implemented with an AI module that may include a plurality of neural network layers. Examples of neural networks include, but are not limited to, a convolutional neural network (CNN), a deep neural network (DNN), a recurrent neural network (RNN), a Restricted Boltzmann Machine (RBM). The learning technique is a method for training a predetermined target device using a plurality of learning data to cause, allow, or control the target device to make a determination or prediction. Examples of the learning techniques include, but are not limited to, a supervised learning, unsupervised learning, a semi-supervised learning, or reinforcement learning. At least one of a plurality of CNN, DNN, RNN, RMB models and the like may be implemented to thereby achieve execution of the present subject matter's mechanism through an AI model. A function associated with the AI model may be performed through the non-volatile memory, the volatile memory, and the processor. The processor may include one or a plurality of processors. At this time, one or a plurality of processors may be a general-purpose processor, such as a central processing unit (CPU), an application processor (AP), or the like, a graphics-only processing unit such as a graphics processing unit (GPU), a visual processing unit (VPU), and/or an AI-dedicated processor such as a neural processing unit (NPU). The one or a plurality of processors control the processing of the input data in accordance with a predefined operating rule or the artificial intelligence (AI) model stored in the non-volatile memory and the volatile memory. The predefined operating rule or artificial intelligence model is provided through training or learning.

As an example, the display unit 1307 includes a computer monitor, a touch screen, an output device capable of displaying the graphics, and the like. The display unit is configured to display visual output on desktops, laptops, and workstations. The display unit may come in different sizes, resolutions, and types (such as LCD, LED, or OLED).

As a further example, the network interface 1309 is configured to provide and establish communication with any electronic device via a public network, private network, or any wireless communication technology.

The figures of the disclosure are provided to illustrate some examples of the invention described. The figures are not to limit the scope of the depicted embodiments of the appended claims. Aspects of the disclosure are described herein with reference to the invention to example embodiments for illustration. It should be understood that specific details, relationships, and methods are set forth to provide a full understanding of the example embodiments. One of ordinary skills in the art recognize the example embodiments can be practiced without one or more specific details and/or with other methods.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Aspects of the present disclosure may be implemented as computer program products that comprise articles of manufacture. Such computer program products may include one or more software components including, for example, applications, software objects, methods, data structure, and/or the like. In some embodiments, a software component may be stored on one or more non-transitory computer-readable media, which computer program product may comprise the computer-readable media with a software component, comprising computer executable instructions, included thereon. The various control and operational systems described herein may incorporate one or more of such computer program products and/or software components for causing the various conveyors and components thereof to operate in accordance with the functionalities described herein.

A software component may be coded in any of a variety of programming languages. An illustrative programming language may be a lower-level programming language such as an assembly language associated with a particular hardware architecture and/or operating system platform/system. Other example of programming languages include, but are not limited to, a macro language, a shell or command language, a job control language, a scripting language, a database query, or search language, and/or report writing language. In one or more example embodiments, a software component comprising instructions in one of the foregoing examples of programming languages may be executed directly by an operating system or other software component without having to be first transformed into another form. A software component may be stored as a file or other data storage methods. Software components of a similar type or functionally related may be stored together such as, for example, in a particular directory, folder, or repository. Software components may be static (e.g., pre-established, or fixed) or dynamic (e.g., created or modified at the time of execution).

While this specification contains many specific implementation details, these should not be construed as limitations on the scope of any disclosures or of what may be claimed, but rather as descriptions of features specific to particular embodiments of particular disclosures. Certain features that are described herein in the context of separate embodiments can also be implemented in combination in a single embodiment. Conversely, various features that are described in the context of a single embodiment can also be implemented in multiple embodiments separately or in any suitable sub combination. Moreover, although features may be described above as acting in certain combinations and even initially claimed as such, one or more features from a claimed combination can in some cases be excised from the combination, and the claimed combination may be directed to a sub combination or variation of a sub combination.

Thus, particular embodiments of the subject matter have been described. Other embodiments are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking and parallel processing may be advantageous.

We claim:

1. A method for identifying root-cause in process variables causing Key Performance Indicator (KPI) deviation in an industrial process, the method comprising:
determining, using ML models, a changed performance characteristics in each asset among a plurality of assets based on a comparison of an expected performance characteristics with respect to a real-time (RT) performance characteristics of each asset;
identifying, based on a result of the determination, a set of key process variables from a plurality of process variables associated with each asset, wherein the set of key process variables includes one or more key process variables that exhibit the changed performance characteristics;
clustering the one or more key process variables exhibiting a similar pattern of the changed performance characteristics to form one or more groups;
selecting, from each one or more groups, a set of substantial process variables exhibiting deviated KPI performance with respect to a target KPI performance based on a distance-based co-relation analysis on the RT performance characteristics of each one or more key process variables with respect to the target KPI performance, wherein the set of substantial process variables includes at least one process variable;
determining a causal effect and causal relation between each substantial process variable in the set of substantial process variables based on a causal analysis on the set of substantial process variables;
determining an order of each substantial process variable causing the KPI deviation based on a knowledge graph; and
identifying the root-cause in the process variables causing the KPI deviation based on an impact of the determined order of each substantial process variable, the causal effect, and the causal relation on the plurality of process variables.

2. The method of claim 1, wherein the determining the changed performance characteristics in each asset among the plurality of assets comprises:
receiving process data from each asset;
determining RT performance characteristics of each asset based on the process data;
comparing, using the ML models, the RT performance characteristics of each asset with the expected performance characteristics; and
determining the changed performance characteristic in each asset based on the comparison.

3. The method of claim 1, wherein selecting, from each one or more groups, the set of substantial process variables comprises:
performing the distance-based co-relation analysis on the RT performance characteristics of each one or more key process variables with respect to the target KPI performance;
determining a degree of similarity in the RT performance characteristics of each one or more key process variables with respect to the target KPI performance, wherein the degree of similarity indicates a degree by which the RT performance characteristics of each one or more key process variables are deviated with respect to target KPI performance; and
selecting the set of substantial process variables from each one or more groups based on the degree of similarity.

4. The method of claim 3, wherein the causal analysis on the set of substantial process variables comprises:
assigning, using the ML models, a contribution weight to each substantial process variable causing KPI deviation, wherein a contribution weight is assigned based on the degree of similarity; and
assigning, using the ML models, a rank to each substantial process based on the contribution weight, wherein the causal relation and the causal effect between each substantial process variable are determined based on the ranking.

5. The method of claim 4, wherein
the knowledge graph is a structured representation of at least one of an interconnection between the plurality of the assets, a relationship between the plurality of the assets, attributes shares between the plurality of the assets, and a hierarchy between the plurality of the assets, and
the knowledge graph is stored in a database.

6. The method of claim 5, wherein determining the order of each substantial process variable causing the KPI deviation based on the knowledge graph, comprises:
analyzing the interconnection between the plurality of the assets, the relationship between the plurality of the assets, the attributes shared between the plurality of the assets, and a hierarchy between the plurality of the assets;
reassigning the rank of each substantial process based on the analysis; and
determining the order of each substantial process variable causing the KPI deviation based on the reassigning rank.

7. The method of claim 1, wherein identifying the root-cause in the process variables causing the KPI deviation, comprises:
determining an impact of each substantial process variable on the plurality of process variables based on the determined order of each substantial process variable, the causal effect, and the causal relation.

8. A system for identifying root-cause in process variables causing Key Performance Indicator (KPI) deviation in an industrial process, the system comprising:
one or more processors;
a memory; and
one or more programs stored in the memory, the one or more programs when executed by the one or more processors, cause the one or more processors to:
determine, using ML models, a changed performance characteristics in each asset among a plurality of assets based on a comparison of an expected performance characteristics with respect to a real-time (RT) performance characteristics of each asset;
identify, based on a result of the determination, a set of key process variables from a plurality of process variables associated with each asset, wherein the set of key process variables includes one or more key process variables that exhibit the changed performance characteristics;
cluster the one or more key process variables exhibiting a similar pattern of the changed performance characteristics to form one or more groups;
select, from each one or more groups, a set of substantial process variables exhibiting deviated KPI performance with respect to a target KPI performance based on a distance-based co-relation analysis on the RT performance characteristics of each one or more key process variables with respect to the target KPI performance, wherein the set of substantial process variables includes at least one process variable;
determine a causal effect and causal relation between each substantial process variable in the set of substantial process variables based on a causal analysis on the set of substantial process variables;
determine an order of each substantial process variable causing the KPI deviation based on a knowledge graph; and
identify the root-cause in the process variables causing the KPI deviation based on an impact of the determined order of each substantial process variable, the causal effect, and the causal relation on the plurality of process variables.

9. The system of claim 8, wherein to determine the changed performance characteristic in each asset among the plurality of assets, the one or more processors are configured to:
receiving process data from each asset;
determining RT performance characteristics of each asset based on the process data;
comparing, using the ML models, the RT performance characteristics of each asset with the expected performance characteristics; and
determining the changed performance characteristic in each asset based on the comparison.

10. The system of claim 8, wherein to select, from each one or more groups, the set of substantial process variables, the one or more processors are configured to:
perform the distance-based co-relation analysis on the RT performance characteristics of each one or more key process variables with respect to the target KPI performance;
determine a degree of similarity in the RT performance characteristics of each one or more key process variables with respect to the target KPI performance, wherein the degree of similarity indicates a degree by which the RT performance characteristics of each one or more key process variables are deviated with respect to target KPI performance; and
select the set of substantial process variables from each one or more groups based on the degree of similarity.

11. The system of claim 10, wherein for the causal analysis on the set of substantial process variables, the one or more processors are configured to:
assign, using the ML models, a contribution weight to each substantial process variable causing KPI deviation, wherein a contribution weight is assigned based on the degree of similarity; and
assign, using the ML models, a rank to each substantial process based on the contribution weight, wherein the causal relation and the causal effect between each substantial process variable are determined based on the ranking.

12. The system of claim 11, wherein
the knowledge graph is a structured representation of at least one of an interconnection between the plurality of assets, a relationship between the plurality of assets, attributes shares between the plurality of assets, and a hierarchy between the plurality of assets, and
the knowledge graph is stored in a database.

13. The system of claim 12, wherein to determine the order of each substantial process variable causing the KPI deviation based on the knowledge graph, the one or more processors are configured to:
analyze the interconnection between the plurality of the assets, the relationship between the plurality of the assets, the attributes shared between the plurality of the assets, and a hierarchy between the plurality of the assets;
reassign the rank of each substantial process based on the analysis; and
determine the order of each substantial process variable causing the KPI deviation based on the reassigning rank.

14. The system of claim 8, wherein to identify the root-cause in the process variables causing the KPI deviation, the one or more processors are configured to:
determine an impact of each substantial process variable on the plurality of process variables based on the determined order of each substantial process variable, the causal effect, and the causal relation.

15. A non-transitory computer-readable storage medium storing program instructions for identifying root-cause in process variables causing Key Performance Indicator (KPI) deviation in an industrial process, the instructions, when executed, perform the steps of:
determining, using ML models, a changed performance characteristics in each asset among a plurality of assets based on a comparison of an expected performance characteristics with respect to a real-time (RT) performance characteristics of each asset;
identifying, based on a result of the determination, a set of key process variables from a plurality of process variables associated with each asset, wherein the set of key process variables includes one or more key process variables that exhibit the changed performance characteristics;
clustering the one or more key process variables exhibiting a similar pattern of the changed performance characteristics to form one or more groups;
selecting, from each one or more groups, a set of substantial process variables exhibiting deviated KPI performance with respect to a target KPI performance based on a distance-based co-relation analysis on the RT performance characteristics of each one or more key process variables with respect to the target KPI performance, wherein the set of substantial process variables includes at least one process variable;
determining a causal effect and causal relation between each substantial process variable in the set of substantial process variables based on a causal analysis on the set of substantial process variables;
determining an order of each substantial process variable causing the KPI deviation based on a knowledge graph; and
identifying the root-cause in the process variables causing the KPI deviation based on an impact of the determined order of each substantial process variable, the causal effect, and the causal relation on the plurality of process variables.

16. The non-transitory computer-readable storage medium of claim 15, wherein selecting, from each one or more groups, the set of substantial process variables comprises:
performing the distance-based co-relation analysis on the RT performance characteristics of each one or more key process variables with respect to the target KPI performance;
determining a degree of similarity in the RT performance characteristics of each one or more key process variables with respect to the target KPI performance, wherein the degree of similarity indicates a degree by which the RT performance characteristics of each one or more key process variables are deviated with respect to target KPI performance; and
selecting the set of substantial process variables from each one or more groups based on the degree of similarity.

17. The non-transitory computer-readable storage medium of claim 16, wherein the causal analysis on the set of substantial process variables comprises:
assigning, using the ML models, a contribution weight to each substantial process variable causing KPI deviation, wherein a contribution weight is assigned based on the degree of similarity; and
assigning, using the ML models, a rank to each substantial process based on the contribution weight, wherein the causal relation and the causal effect between each substantial process variable are determined based on the ranking.

18. The non-transitory computer-readable storage medium of claim 17, wherein
the knowledge graph is a structured representation of at least one of an interconnection between the plurality of the assets, a relationship between the plurality of the assets, attributes shares between the plurality of the assets, and a hierarchy between the plurality of the assets, and
the knowledge graph is stored in a database.

19. The non-transitory computer-readable storage medium of claim 18, wherein determining the order of each substantial process variable causing the KPI deviation based on the knowledge graph, comprises:
analyzing the interconnection between the plurality of the assets, the relationship between the plurality of the assets, the attributes shared between the plurality of the assets, and a hierarchy between the plurality of the assets;
reassigning the rank of each substantial process based on the analysis; and
determining the order of each substantial process variable causing the KPI deviation based on the reassigning rank.

20. The non-transitory computer-readable storage medium of claim 15, wherein identifying the root-cause in the process variables causing the KPI deviation, comprises:
determining an impact of each substantial process variable on the plurality of process variables based on the determined order of each substantial process variable, the causal effect, and the causal relation.
